(19) United States
(12) Patent Application Publication
(10) Pub. No.: US 2012/0318117 A1
(43) Pub. Date: Dec. 20, 2012

(54) Stringed instrument improvements

(76) Inventor: Brent Deck, (US)

(21) Appl. No.: 13/597,252

(22) Filed: Aug. 28, 2012

Related U.S. Application Data
(63) Continuation-in-part of application No. 12/842,028, filed on Jul. 22, 2010.
Application No. 12/842,028 is a continuation-in-part of application No. 12/283,668, filed on Sep. 15, 2008, now Pat. No. 8,252,999.
(60) Provisional application No. 61/529,910, filed on Aug. 31, 2011.
(60) Provisional application No. 61/271,586, filed on Jul. 22, 2009.
(60) Provisional application No. 60/960,075, filed on Sep. 14, 2007.

(51) Int. Cl. G10D 3/00

(52) U.S. Cl. 84/313

(57) ABSTRACT

This invention relates to improvements to a stringed musical instrument, and more particularly to guitar design for use with transposing vibrato mechanisms.

Vibrato devices for guitars are known. The present device and method improve the ability to of a player to bend entire chords in a manner that maintains harmonic relationship between the individual strings.

The invention also included improved manual controls and means to extend the transposing range of such a vibrato device.

This application claims priority to U.S. provisional application 61/529,910 filed Aug. 31, 2011, by the present applicant.

This application is a continuation in part of U.S. non-provisional application Ser. No. 12/842,028 filed Jul. 22, 2010 by the present applicant, which claimed priority to U.S. provisional application 61/271,586 filed Jul. 22, 2009 and to PCT application U.S. Ser. No. 10/27736 filed Mar. 17, 2010.

This application is a continuation in part of U.S. non-provisional application Ser. No. 12/283,668 filed Sep. 15, 2008 by the present applicant, which in turn claimed priority to U.S. provisional application 60/960,075 filed Sep. 14, 2007.

The disclosure of this application incorporates by reference the entirety of said application Ser. Nos. 12/283,668 and 12/842,028.

Said incorporation by reference shall supplement the present disclosure without in any way limiting the scope or meaning of the disclosure or claims of the present application or subsequent applications.

### FIELD OF INVENTION

The present invention relates to devices which enhance the expressive qualities of a stringed musical instrument by empowering the artist to “bend” notes and chords in a harmonic manner.

### SUMMARY

This application discloses various embodiments having guides adjustably fixed relative to a pivoting tailpiece, causing the strings to be stretched or relaxed when the tailpiece is rotated, enabling maintenance of relative pitch among strings.

The application dicloses dual axis control, ebabling a musician to sweep easily from “bend” to “dive” (sharp to flat) while using the muscles on only one side of the hand and wrist. Dual axis control further allows biasing a tailpiece against a separate stop on a separate axis after either a bend or a dive, with enhanced stablity at neutral pitch, and requiring no locking mechanism.

The application discloses various embodiments of a cam-enabled return spring to maintain neutral tuning when the device is released without adversely affecting motion of the device.

Embodiments also include a beneficial combination of pitch-relative and non-pitch-relative vibrato means, where a non-pitch-relative vibrato displacement may be used to compensate for non-linearities in string tension while transposing over large spans.

Also disclosed are various embodiments enabling improved electronic control, improved limitation on string stress, improved float about a neutral position, improved flex compensation, improved string anchoring, improved fulcrum support, and improved bending means for individual strings.

### DRAWINGS

Letters I and O are omitted from figure designations in the interest of clarity.

FIG. 1A shows an end view of an embodiment of a vibrato control arm having a rotational axis substantially parallel to the stings, where the body is cutaway to show an embodiment of vibrato connection and biasing means.

FIG. 1B show a top view of an embodiment of a vibrato control arm having a rotational axis substantially parallel to the stings, and of drum on an axis substantially parallel to the strings for manipulating an electronic rotation sensor.

FIG. 1C shows an end view of an embodiment of a vibrato control having a rotational axis substantially parallel to the stings, where the control comprises at least a partially arcuate surface.

FIG. 1D shows an end view of an embodiment of a vibrato control having a rotational axis substantially parallel to the stings, where the control arm comprises a substantially planar surface

FIGS. 2A through 2H and 2J are side views of embodiments of alternative means of positioning a string guide about an arcuate path with respect to a rotating member.

FIGS. 3a through 3c show side views of embodiments having means for limiting the stretch of a string to allow more extreme bends

FIGS. 4A, 4B, and 4C illustrate basic elements of flex compensation in examples where the members are string-engaging members are not necessarily articulated.

FIGS. 5A through 5C show progressive side views of a vibrato device having a cam enabled dive capability.

### DESCRIPTION

In this discussion, traditional, non-transposing vibrato action and components thereof shall be referred to as “standard”; e.g. standard dive, bias, bend, bias stop. Pitch-relative vibrato action and components thereof shall be referred to as “harmonic”; e.g. harmonic dive, bias, bend, bias stop.

### Bias Limit Cam Notes

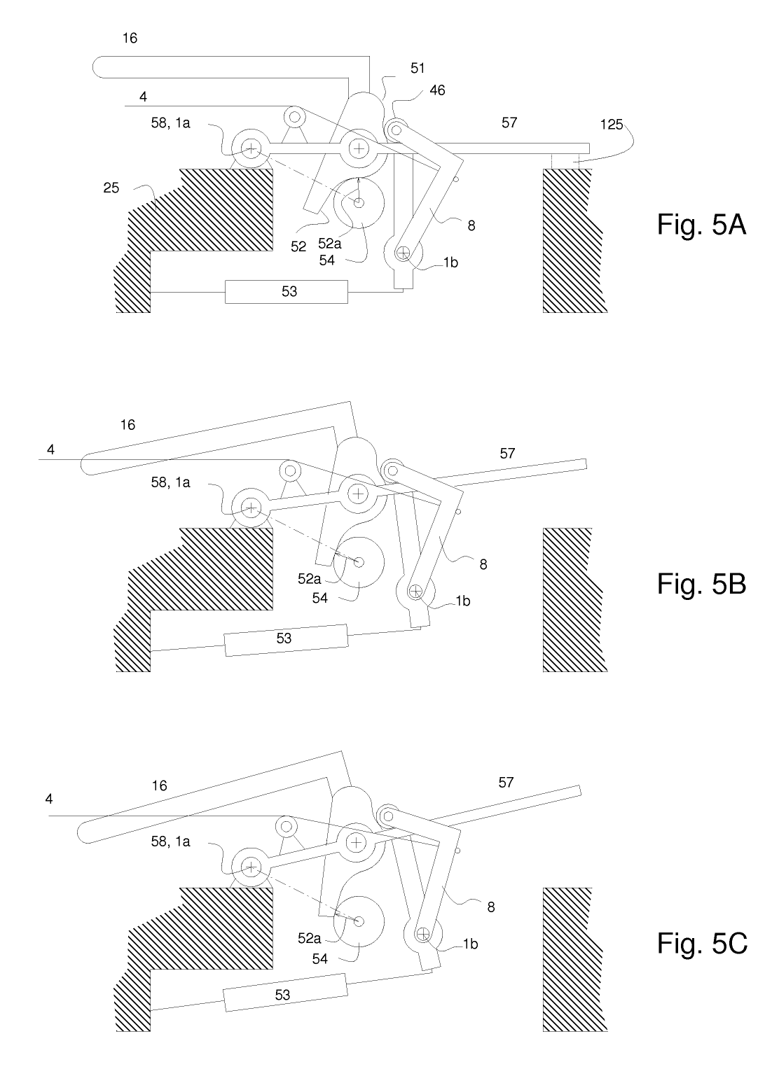

In an embodiment of a bias cam and follower in FIG. 5c, at least a part of the cam surface 52 is configured to engage follower 54 at a location opposite a ray between the follower axis and the transport axis 58 from a handle of on the control arm 16. Said location allows a small rotation of the control arm to effect a relatively larger displacement of transport 57. In a preferred embodiment of this feature, the engagement crosses said ray during the initial rotation of the arm, thus changing from a light touch near neutral position to a large tonal change near the end of the arm stroke. In at least one embodiment, axis 58 of is substantially parallel to the string plane, or to the bridge.

More generally, in FIGS. 5A, 5B, and 5C, a transport 57 biased in opposition to tension of strings 4 by spring means 53 pivots on an axis 58 relative to a base 25. As shown in FIGS. 5B and 5C, at least a portion of dive cam surface 52 is configured to engage follower 54 in alignment with a force vector 52a generating a torque about axis transport axis 58 in opposition to the desired direction of rotation of the transport about the axis, and in opposition to the torque of the lever 16.

In such a configuration, and in other configurations, the cam and follower (regardless of whether they act as a bias stop) act to limit the rotation of the arm in a way that shortens its stroke and reduces its purchase, while enabling a greater rotation of the transport device than would be possible even if the arm were locked to the transport. Such contact between cam and follower enables the transport to rotate through a greater angle than the arm itself.

In the example, the movable tailpiece member 8 is urged by string tension to engage a bend cam follower 46 with a bend cam 51. A bias limiter comprising a dive cam 52 and follower 54 may optionally employ a fixed stop 125, for example in addition to or in lieu of a constant radius dive cam surface to oppose bias spring force at rest or during a bend. Similarly a fixed stop may supplement the bend cam and follower. Dive cam follower 54 preferably rotates about an axis fixed relative to a base, for example base 25.

In the example, the movable tailpiece member 8 pivots about axis 1a relative to base 25 during a dive, and pivots about bend axis 1b relative to biased transport 57 during a bend. (presuming engagement of a zero-slope dive cam surface during a bend, and a of zero-slope bend cam surface during a dive) In alternative embodiments, either of said bend and dive axes 1a and 1b are associated with a biasing transport, or a base, or another moveable member.

It should be noted that at least one embodiment includes the dive cam so described, without association with the bend apparatus of the figure.

Alternatively separate arms (preferably extending oppositely) may be provided for dive and bend cams, for example the cam surfaces of FIG. 5A. Said cam axes are preferably not concentric, and said axes are preferably parallel to the bridge.

### Flex Compensation

The performance of any transposing vibrato device will suffer during excursions over multiple tonal steps on a low-modulus instrument, because the effects of neck deflection are non-linear with respect to changes in string tension. An embodiment of the present invention compensates for neck flex and other nonlinear displacements by moving use of two moveable tailpieces members engaging a common set of strings, the first configured to change string pitch in a harmonic manner, the other to alter string pitch in a more uniform or non-harmonic manner.

A compensator associates motion of one tailpiece member with the other and the compensator is preferably adjustable in a manner so that the combined displacements of the two tailpiece members may be characterized to compensate for the deflection of the instrument.

In a preferred embodiments, one of the tailpiece members moves relative to the other, for example a harmonic tailpiece member moveable relative to a base comprising a standard tailpiece member, where the standard member, pivots relative to the instrument.

Compensation means, in the form of a cam, wedge, crank, screw, or other means preferably translates motion of moving component associated with the harmonic tailpiece member to motion of a non-harmonic tailpiece member.

If the compensator comprises cam means, an adjuster or adjusters preferably enable reshaping the cam and/or repositioning the cam or cam follower

### Simulated Dual Axis Operation

Still another alternative embodiment of the invention simulates dual axis control by extending the control arm from pivot means having a pivot axis substantially parallel to the strings.

Rotation of said arm toward the strings engages the vibrato device through suitable mechanical means to generate a bend effect, while rotation away from said strings and toward instrument body generates a dive effect. Said device preferably includes one or more biasing means to provide a free floating or a stable floating effect about the neutral position.

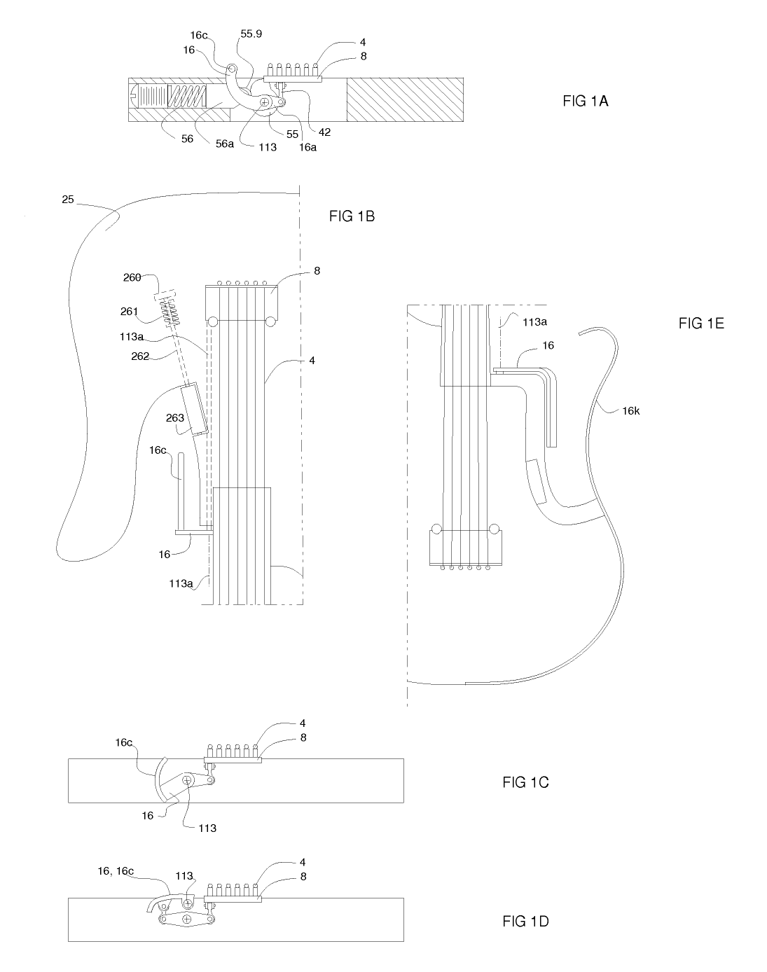

FIGS. 1A and 1B illustrate an example where the pivot means is a shaft 113a rotating on axis 113, preferably substantially below and parallel to the strings. An arm 16, preferably curved to provide suitable neck and body clearance, radiates from said shaft, having a handle 16c, also preferably parallel the strings 4.

The shaft engages the vibrato unit by suitable means, for example by a connecting rod 42 pivoting on crank arm 16a extending from the shaft 113a, and attached to a moveable member 8, as illustrated in FIG. 1A.

The device may utilize any biasing means, e.g. simple bias springs (not shown) connecting the rotating member 8 or a crank from shaft 113a to the instrument body 25.

In the example shown in FIG. 1A, the biasing means for the vibrato rotating member 8 is provided by return spring 56 pressing cam follower 55.9 toward cam 55, also rigidly attached to shaft 113a. The angle of contact of the cam with the follower is preferably adapted generate forces opposes to the string tension Preferably a slight change in angular contact at the neutral position provides tuning stablity when the return spring 56 is properly adjusted, as previously disclosed.

The camfollower 55.9 rotates on a shuttle 56a (or alternatively a rocker) providing stable contact between cam 55 and cam follower 55.9 by confining the cam follower to a linear or arcuate path, and resisting unwanted tangential motion of cam follower about the cam.

The actuation arm 16c, substantially parallel to the strings in FIGS. 1A and 1B may alternatively have the shape of a cylindrical control surface (not shown), preferably coaxial with shaft 113a, and of sufficient radius and surface friction to enable a rolling action with the palm side of the fingers while playing.

In examples of alternative embodiments, the combination of arm 16, shaft 113a, and handle 16c, take the form of a full or partial drum surface as in FIG. 1C, or a contoured or substantially planar surface (for example a pickguard) hinged along an axis substantially parallel to the strings, as in FIG. 1D.

In alternative embodiments, the biasing means includes a cam and follower, at least one of which is moveable relative to a base, where rotation of the arm 16 is associated with relative motion of said cam and cam follower, such that rotating the arm 16 in one direction (preferably downward, away from the strings) alters the bias position of the main member 8 in a direction of increased bias spring force, for example similarly to the device described with respect to FIG. 9C. Shaft 113a may connect directly or indirectly to said one or more cam, and may be configured to bend or swivel or link to intermittent arm or shaft means.

### Mutes

A preferred stringed instrument configuration includes a volume or muting control having a preferably cylindrical control surface moveable in a direction substantially tangential to an axis substantially parallel to the strings, for example a finger wheel 263 as shown in FIG. 1B.

This surface is associated (preferably by a shaft 262) with an electronic sensor 260 (preferably a potentiometer) wired, for example as a volume control, or as a separate muting (or gain) control, with the control surface immediately adjacent the strings, and with shaft axis substantially parallel to the strings.

Typically the volume control on an electric guitar comprises a potentiometer of high resistance relative to the pickups, wired as a shunt parallel the pickups. The main volume control pot is sometimes used as a mute by dragging the edge of the small finger against a knurled knob. A present embodiment improves control by exposing a preferably cylindrical surface 263 to the inner surface of the fingers as shown. This pot may be used as the main volume control pot, or it may be a separate dedicated muting pot, preferably parallel to the first.

An embodiment of a pot suitable for mutes and swells is illustrated in FIG. 1B, and preferably includes a return spring 261 or a detent (not shown) associated with shaft 262, returning the pot preferably to a high shunt impedance after use, or preventing inadvertent rotation. The spring is preferably of a non magnetic material to prevent interference with magnetic pickups. Alternatively, the shaft 262 between the finger wheel 263 and the pot 260 is long enough to effectively isolate the spring from the pickups, as illustrated. The muting pot preferably generates essentially infinite resistance at rest (when used for muting) and may preferably be rotated to drop to zero resistance.

In one embodiment the muting pot may be switched (preferably by simple electrical switch means) from a muting function to a controller function as described with regard to an electronic vibrato arm. The device may alternatively be adapted to control other functions or effects without regard to muting.

In another embodiment a device (such as a pot) connected to a single wheel when rotated one direction serves one function (such as muting), and when the wheel is rotated in the opposite direction from neutral the same device or a separate device connected to the same wheel serves a second function (such as control of an internal or external effects controller by connection thereto)

In another embodiment multiple control surfaces (for example wheels or paddles) rotating on concentric or parallel shafts connect to separate (preferably resistive) devices to control multiple functions. An embodiment includes a separate return spring associated with each of one or more wheels or paddles.

Connection to an external effects controller is, for example, by any of the means described with regard to an electronic vibrato arm sensor.

The at rest resistance of a resistive device used to control an external device is preferable switchable (for example by reversing the connections on a pot to change the direction of operation) and configurable (for example by connection to a parallel characterizing pot to adjust the rate or range of operation.) In another embodiment any of multiple resistive devices associated with the same control surface are switchably interchangeable in a common circuit.

The body (FIG. 1B) preferably has sufficient open area to allow clearance for manipulating the control arm 16 or control surface 263, or both. To enhance the open area in an embodiment shown in FIG. 1E, a cantilever knee rest 16k of high strength material, for example steel or composite, is fastened to a body of a generally weaker material (e.g. wood) by suitable means, for example wood screws or adhesive resin. In alternative embodiments a reinforcing material is molded into or attached to a body having a cantilevered knee rest portion.

It should be understood that in at least one embodiment, either of the shafts 113a or 262, or the actuator drum 263 of FIG. 1B engages an electronic sensor (for example a potentiometer) configured to or switchable to provide a (preferably resistance) signal to an effects processor for the pu.

Flex Notes

While the preferred embodiment comprises a harmonic vibrato tailpiece rotating relative to a substantially standard vibrato tailpiece, in order to simply and economically take advantage of the elevation of the strings during a dive, any separately movable tailpiece component, movement of which causes substantially uniform changes to the stretch of the strings, may, when combined with a harmonic vibrato device be used for flex compensation if actuated at the proper rate.

For example the string anchors 10 may be mounted to a flex compensation base which in turn moves relative to harmonic main rotating member 8.

Or, for example, the string bearings 3 may be mounted to a base 69, with base 69 and rotating member 8 both rotating about a common sub base 75.

Any combination of components substantially equivalent to the combination of a standard vibrato tailpiece and a harmonic vibrato tailpiece may be used to create a flex compensated harmonic vibrato device. (A tailpiece may be redirecting, and need not have its own anchors)

The compensated device preferably includes machinery to elevate the bridge during a dive, to reduce string buzz. In the preferred embodiment, the bridge elevation machinery is associated with the flex compensation machinery, as disclosed elsewhere in this document.

Flex compensation as disclosed here and as illustrated in the figures comprises an operatively associated combination of devices for simultaneous harmonic displacement and substantially uniform displacement of multiple engaged strings. Each of the two displacement devices engages a common set of strings directly or indirectly, and displaces the string in the region of engagement so as to change the elongation and tension of the string.

Each of the harmonic and uniform devices preferably displaces strings by rotation of anchors or guides about an axis.

The two devices may be articulated, so that one pivots relative to the other, or they may be separately connected to a base or instrument body.

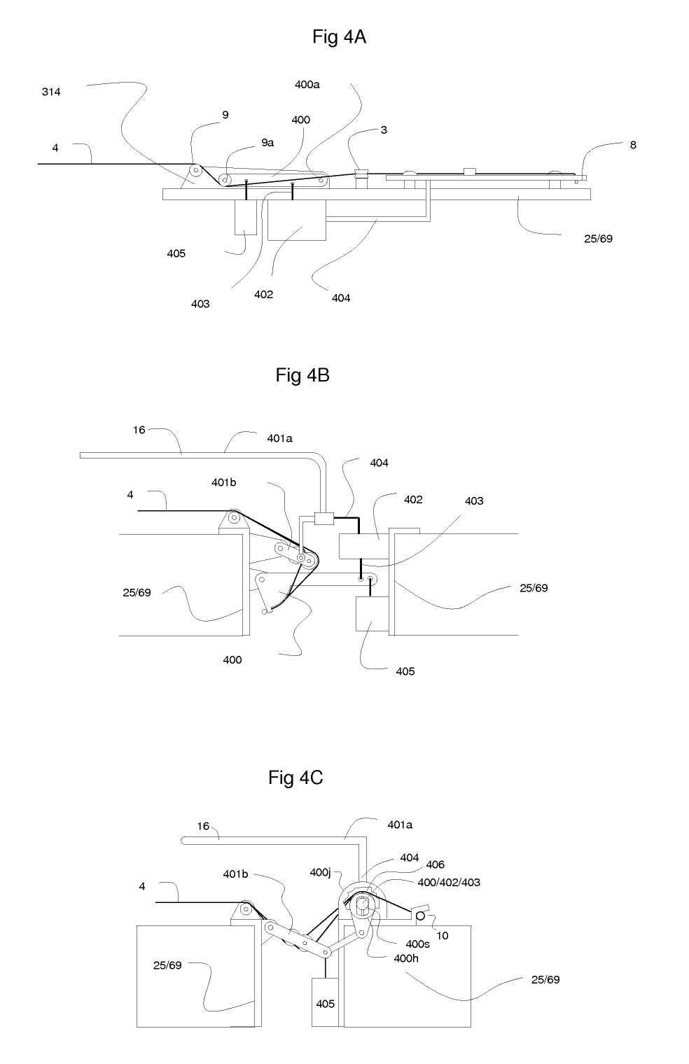

FIGS. 4A, 4B, and 4C illustrate basic elements of flex compensation in examples where the pieces are not articulated.

The string anchors may be, for example, on a standard vibrato tailpiece, a harmonic vibrato tailpiece, a base, a separate fixed tailpiece, or the instrument body.

(The substantially uniform displacement device may provide separately adjusted or fixed nonuniformity of displacement to compensate separately for slight variations in string modulus, for example by providing guides or anchors adjustably positioned relative to a pivot axis)

The combination involves associating the motion of a characteristic moving harmonic displacement member 401 (for example a rotating tailpiece, control arm shaft, or transposing hub) with the motion of a substantially uniformly displacing member 400 by way of compensation machine 402.

The compensation machine 402 is preferably or adjustably characterized to match the motion of the harmonic and uniform devices in such a manner that for any string displacement by the harmonic member 401, the string displacement by the uniform member 400 will substantially cancel the string displacement due to instrument deflection under varying string tension.

Compensation machine 402 (which may include any characterizable machine or combination of machines, for example a flexibly adjustable cam, an eccentric, a crank, a rocker, a lever having adjustable length and engagement delay, or a screw) is shown in FIG. 4A as a black box engaged by a rotating harmonic tailpiece 401 (via engagement means 404) to make a slight adjustment to the uniformly displacing member 400 (via engagement means 403).

Some or all of the compensation machinery may be inherently incorporated into one or both of the string displacement devices.

In FIG. 4C, for example, the machine may comprise string-bearing idler sheaves 406 mounted eccentrically relative to a shaft or journal, where the degree of eccentricity and at-rest angle of engagement with the strings are preferably separately adjustable. The shaft may be activated for example directly by the control arm 401a, and output from the machine may be directed to the harmonic tailpiece 401b. The eccentric assembly itself may be considered both part of the uniform tailpiece 400 and the compensation machine 402. In the example of the figure, the eccentricity of shaft 400s is adjustable within a slotted hub 400h, rotating in journal support 400j, preferably fixed relative to base 69 or body 25, as are string anchors 10. Uniform displacing member 400 may share a common bias spring with harmonic tailpiece 401b.

In unshown examples, the sheaves 406 may be replaced by cam or cams engaging the strings or separate moveably tailpiece(s). The anchor 10 may alternatively be fixed relative to said cams or said shaft, and the cams may for example be pressed into sheet stock pivoting on a knife edge fulcrum.

For simpler use of cams in compensation machine 402, in a preferred configuration, bias spring means 405 preferably opposing string tension, urge the uniform tailpiece in a direction limited by compensation machine 402. In this configuration, the radius of a cam follower is less likely to interfere with the cam dimensionally. However, machine 402 may exert force in either direction, and no bias spring is required.

Machine 402 and bias spring means 405 are preferably configured to engage base 69 or body 25, as shown. But may alternately engage an intermediate base as previously described or a moving component as a reference structure.

It should be noted that at least one embodiment comprises separate devices for flex compensation in each of the bend and dive directions, either or both of which is adjustable.

It should be noted that at least one embodiment comprises in combination a moveable member, motion of which causes a harmonic change in string pitch of at least two strings, an another moveable member, motion of which causes a substantially non harmonic change in string tension, said members mechanically associated with each other such that motion of one causes motion of the other, where the degree of association is configured or configurable to compensate for flexibility of the instrument to which the device is attached.

Transport Separate from Device

It should be noted that any part or all of the control arm and transport combination may be mounted apart from the other components of the device and connected by linkage above, below, or through the body of the instrument.

For example, mounting the control arm pivot axes farther toward the tuning head allows good tactile response due to the improved angular purchase, while avoiding clutter on the face of the body.

### Hidden Mechanism.

It should further be noted that the disclosed device may be fabricated with any part or all of the actuation mechanism concealed within the instrument (or for example, below a pick guard), including control arm pivot, transport means, and transposing means, and associated springs.

Said device may be implemented as a retrofit unit or built into an instrument. Said instrument body may act as the base or sub-base previously described.

In particular, the control arm shaft or shaft extension may extend below the hub or a cam or rocker may be extended from the control arm hub through the base to engage the spring block below the face.

### Cantilevered Guide

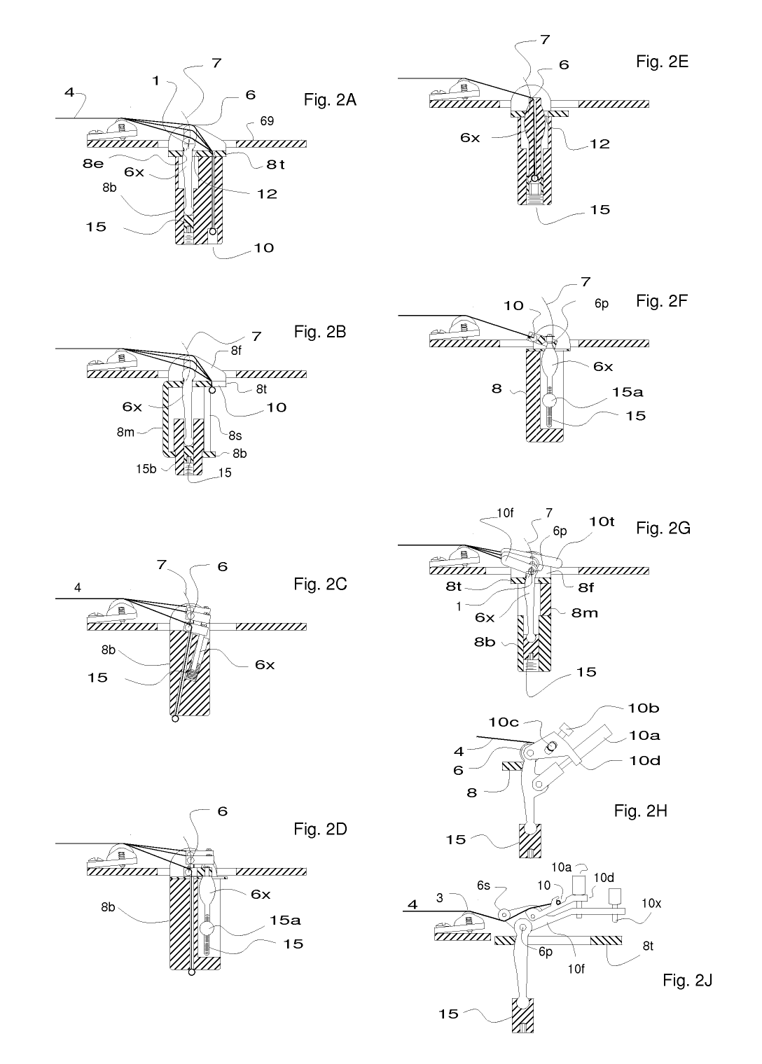

In FIGS. 2A through 2J, for one or more strings an adjuster (preferably a screw 15 in a lower block 8b of main rotating member 8) is used to push guide 6 on the end of guide extender 6x away from main pivot axis 1. Guide extender is preferably a column extending through a preferably slotted base plate plate 8t (in FIGS. 2A, 2B, 2D, and 2E), where the slots 12 are preferably sized to prevent passage of lower end of extender 6x when unstrung.

Shape of front edge (toward bridge) of extender 6x and location of front edge 8e of slot 12 are preferably matched to position guide 6 along a suitable arcuate path 7. Extender may be straight, as shown in FIG. 2C or curved as in FIG. 2A. FIG. 2C also shows an alternative embodiment where guide extender 6x comprises bulbous adjuster screw 15 engaging preferably flat or convex threads in at least one side wall of the socket, allowing column to tilt as it extends, with the upper end resting against the top lip of a socket. Side wall threads are preferably provided by a threaded rod inserted into an adjoining socket.

In a preferred configuration, side walls of a slot for an individual guide column 6x are provided by parallel packing of adjacent guide columns into position.

In the examples of FIGS. 2C and 2D, guides 6 are preferably pivotingly cantilevered from a cantilevered column 6x to resist string tension. The column in the 2 examples preferably comprises a threaded shaft with straight cylindrical or contoured surface.

In FIG. 2D, a transverse rotatable cylinder 15a rotates about a fixed axis in block 8b, being threaded to adjuster screw 15 on the end of guide extender 6x.

In FIG. 2E column 6x may be turned to shape (for example on a screw machine) with internal string path and anchor 10, with swiveling ball and socket connection on adjuster screw 15 to resist axial motion of the column, and preferably with machined flats on the sides to resist rotation in slots 12.

FIG. 2F shows a string anchor (for example a ball cup) suspended in tension, and pivotable about 2 axes relative to a cantilevered guide support column, for example suitable for connection to a cantilevered column modified from those shown in FIG. 2C, 2D, or 2E. Connection in the example is by a countersunk knife edge riding in a turned groove.

FIG. 2G shows a string anchor (for example a ball cup) suspended in tension, and pivotable about 1 axis, preferably centered on arcuat guide path 7, for example suitable for application to a cantilevered column modified from one shown in FIG. 2A, 2B, or 2E. In a preferred configuration, pivoting anchor 10 has includes a tail 10t enabling balancing of the anchor by finger pressure during loading. A ball cup or string slot may be in either end of the extended anchor.

In FIGS. 2F and 2G the guide position adjuster 15 preferably includes retaining means (for example a ball socket in a setscrew in FIG. 2G) to prevent motion of the column in either axial direction from the adjusted position.

Similarly (for example in FIG. 2H) an anchor (for example a combined fine tuner 10d and string clamp 10c, adjustable by setscrews 10a and 10b) may be attached to one or more guide columns. The fine tuner preferably pivots about the focus of a preferably cylindrical guide 6. String engaging surface of guide 6 may be fixed relative to the cantilevered column, or it may comprise a revolving sheave. Column adjuster 15 includes means to prevent axial motion of the column, for example a ball retainer as shown, or for example dual opposed setscrews, not shown.

In FIGS. 2A, 2B, and 2G, keying means between guide column 6x and rotating member 8, for example parallel slots in top plate 8t shaped to fit columns 6x having rectangular cross section, preferably substantially resist rotation of column 6x about its longitudinal axis.

In Fix 2A through 2H, cam follower means, for example, top plate edge 8e positions the cam face of cantilevered guide support column 6x. Alternative follower embodiments comprise roller or shaft means Preferably a flange 8f extends from the block 8b or the top plate 8t to support pivot means for the tailpiece 8 to rotate about main axis 1. A flange 8f, for example, comprises a journal hole, a cantilevered shafts, or a knife edge fulcrum component positioned to enable pivoting of main member 8 about main axis 1 (pivot means not visible)

In the embodiments of FIGS. 2F, 2G, and 2J, string guide 6 is a pivot for a string anchor, so that the tension of the string acts to align the string with the guide pivot axis 6p.

The guide axis itself is preferably adjustable along an arcuate path 7 substantially as previously described in the present text or the parents, where the string axis intersects the guide axis at a defined angle relative to a ray from main axis 1, about which first member 8 rotates.

FIG. 2J illustrates an example of an anchor fixture 10f pivoting freely on guide 6 about guide pivot axis 6p. The fixture is preferably associated with a guide surface 6s (preferably a smooth convex shape or a roller) configured to engage the string 4 between the string bearing 3 (a bridge saddle in the example) and the string anchor 10, preferably with string 4 wrapping slightly about guide surface 6s. The string tension urges surface 6s angularly about axis 6p in opposition to the urging of string anchor about axis 6p, thus urging alignment of string 4 with guide pivot axis 6p.

In and example shown in FIG. 2J, anchor fixture 10f is associated with a fine tuner. A fine tuner associated with an anchor fixture may take any suitable form. In the example, the fine tuner is a lever 10d pivotable relative to fixture 10f and comprising an adjuster 10a. In the example, the fine tuner lever 10d supports a string anchor 10, illustrated, for example, as a ball cup.

In an alternative embodiment anchor 10 further comprises a string clamp, for example as illustrated in FIG. 10H. In an alternative embodiment, a fine tuner engages a string between guide surface 6s and anchor 10. In another embodiment, the fine tuner adjusts the position of guide surface relative to the anchor fixed relative to an anchor fixture. In another embodiment, an anchor fixture comprises a guide surface and an anchor with no fine tuning adjuster.

In the configurations of FIG. 2F, 2G, or 2J pushing either direction on an individual anchor 10 or anchor fixture 10f (directly or with a lever extended for that purpose, for example a palm lever) enables bending an individual string to a higher pitch. In one embodiment, a bend limiter, for example limit screw 10x, in FIG. 2J, allows bending a string a desired interval by rotating fixture 10f in one direction, while allowing greater rotation in the opposite direction. Configured as shown, rotating fixture 10f beyond its limit causes rotation of the entire main member 8. Additional improvements not shown in the figure are a separate lever to improve the mechanical advantage or rotating the fixture towards its limit, to reduce the urge toward premature chord bend during an individual string bend, and compensation to effective guide radius from main axis 1, during a string bend.

In the discussion of all FIG. 2, it is understood that main rotating member 8 describes the combination of all of members 8b, 8e, 8t, 8m, and 8f that exist in that figure.

In at least one embodiment of devices illustrated (for example FIG. 2G) moveable member 8 is fabricated from a stack of sections (for example a top plate 8t, a bottom block 8b, and a middle block 8m) fastened together preferably by tie rods or screws (not shown). Any of the 3 sections may be fabricated by any one or combination of, for example, extrusion, cutting, drilling, boring, milling, broaching, and tapping. In a simple embodiment a lower section 8b is extruded having only round holes, some of which are tapped to receive an adjusting screws 15. Others (for example string anchor holes or FIG. 2A) are preferably counterbored with a tapered shoulder to reduce stress on ball end lashing. Other extruded holes enable tierods or. An embodiment of the middle section is preferably a slotted extrusion, or an extrusion of slots and string holes, or it may comprise multiple simple standoff means between upper and lower sections. In one embodiment the upper section is a slotted plate, but in another it is a continuation of the slotted extrusion, machined to include pivot means (for example bearing shaft bores) centered at main axis 1, for pivotably engaging base 69.

FIG. 2B illustrates an alternative embodiment where flanges 8f, bottom plate 8b, middle plate 8m, and top plate 8t are cut and formed preferably from a single sheet of metal, preferably by simple stamping operation. The configuration preferable comprises at least one stiffener 8s (preferably a standoff between top plate 8t and bottom plate 8p), and adjuster bosses 15b, fastened to the formed plate, for example, by pressing, welding, peening, or screwing. Bosses 15b are preferably fabricated by screw machine. In alternative embodiments boss 15b is formed and threaded into base plate 8b, or adjusting screws 15 threaded directly through a flat bottom plate 8b.

The discussion of FIGS. 2A through 2J has centered on features related to rotating member 8 and string guides 6. Other optional or necessary components to a device are not shown in the figures.

### Bend Limiter

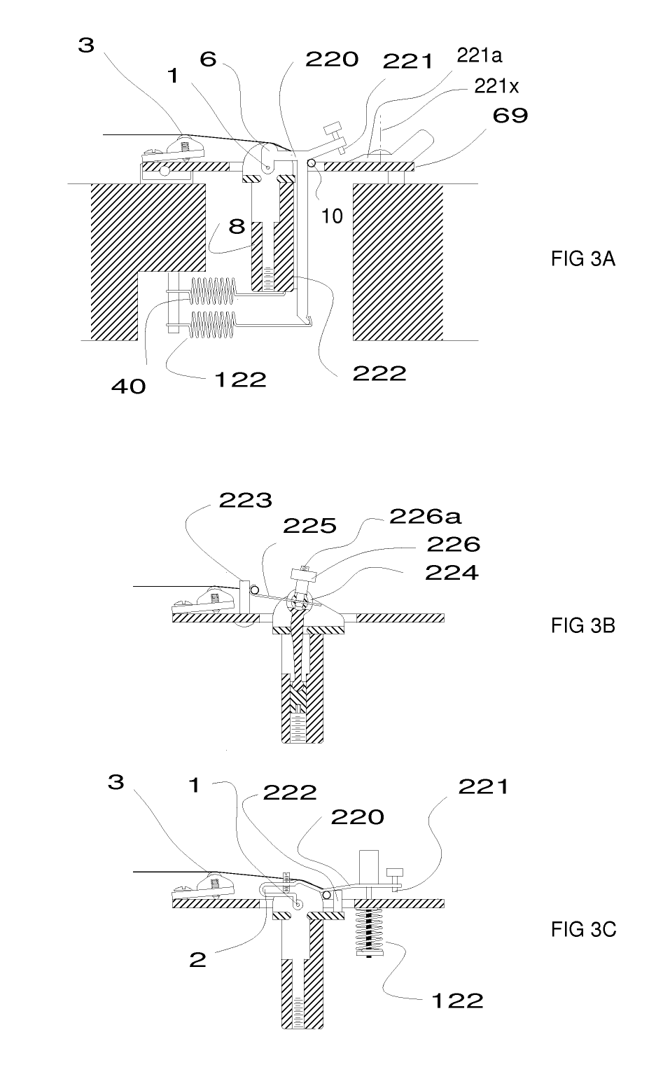

In the embodiments of FIGS. 3A and 3C a separately biased guide crank 220 is provided for at least one sting. It preferably rotates on a common axis 1 with main rotating member 8, and rests against a stop 222 relative to main member 8. As main member 8 rotates in a bend direction, guide crank 220 rotates with it under the force of separate bias spring 122, until preferably adjustable (by an adjusting screw, for example) stop 221 engages base 8. In the example, crank 220 comprises string anchor means 10, for example a slot positioned to enable string 4 to wrap over the surface of guide 6. In a preferred embodiment, a quickly changeable adjuster, for example a sloped or stepped axial cam 221a in FIG. 3A between stop 221 and base 69 (pivotable about an axis 221x), enables a user to quickly select from among 2 or more bend limits during a performance. The range of adjuster 221a preferably is sufficient to enable adjusting the limit to totally prevent bend (sharpening) motion of crank 220 relative to base 69. Adjuster 221a preferably comprises knob or lever means as shown to enable quick adjustment.

The separate crank 220 preferably includes string anchor means separate from the main member, for example a slot for receiving the ball end of a string, as shown, preferably far enough from the guide 6 to isolate the guide from the stiffness of ball end lashing. Main member may optionally be partially biased by separate balancing spring 40.

The radius of guide 6 from axis 1 may be adjustable, for example by set screws on a flexible guide bracket 220, as illustrated in FIG. 3C, or it may be fixed, for example as illustrated in FIG. 3A. A single fixed guide permits all other guides to be adjusted relative to the fixed guide to accomplish tuning of the device. Actuation effort may be adjusted by modifying the purchase of the actuator mechanism between the control arm and main member (not shown).

In FIG. 3B one or more guide means may be equipped with locking slide means, for example a string anchor 225 adapted to slide through or around a modified guide 224 and biased by string tension against a stop 223. Locking means, for example a thumbwheel 226 (or cam, lever, or latch), associates modified guide 224 with sliding anchor when desired. In one embodiment thumbwheel 226 is threaded onto a threaded shaft 226a through cylinder rotating within a guide cavity, with anchor means 225 extending through the cylinder and the threaded shaft. Tightening said thumbwheel pulls anchor against interior of cylinder. When disengaged rotation of main member 8 has no discernible effect on pitch of the disengaged string.

### Electronic Vibrato

An electronic embodiment of control means, as discussed in a parent application, provides an arm rotatable about one or two axes, with rotation resisted by spring means and a force or position sensor measuring rotation about at least one axis. Sensors previously illustrated may be of any type, for example piezoelectric, strain gage, potentiometer, inductive, magnetic, or capacitive sensors, and may generate analog voltage, analog current, digital, or frequency signals when connected to a suitable power source, or simple resistance values. In a preferred embodiment, an arm is configured to attach to a standard vibrato device, and rotation about an axis parallel to the strings actuates a sensor, for example a potentiometer, configured to be connected to an external processor.

### Clarifications Notes:

Not all embodiments of the disclosed invention are are described here.

It is understood that a device configured to accept modification to include elements described here falls within the scope of this disclosure, as do elements configured to be added to a device such that the modified device falls contains disclosed elements.

It is understood that, where applicable, flex compensation may be added to an embodiment for which it is not illustrated, and that one embodiment of flex compensation may be substituted for any other.

It is understood that, where applicable, a bend or dive latch may be added to an embodiment for which it is not illustrated, and that one embodiment of a latch may be substituted for any other.

Stated position or orientation of an axis, journal, or shaft, unless otherwise stated, generally refers to orientation at-rest or at neutral position, where the axis may be associated with a moveable component, the movement of which would change the orientation of the axis, journal, or shaft.

Pivot or rotation means may include flexible solid connection approximating the functionality of a pivot, where practical.

In a description including an instrument body, it is understood where practical, that a separate discrete base fixed or moveable relative to the body may be substituted to fill the function of the body in an alternative embodiment. Likewise a body may be substituted for a base in alternative embodiments.

It is understood that, where practical, for any disclosure of a device having a control arm rotating relative to a discrete moveable transport device, an alternative embodiment includes a control arm rotating about two axes on a hub in hub retainer, where one of two pivot axes rotates relative to a hub retainer.

Use of common terms of the trade, for example “tone block” is meant to aid in identifying a component in a drawing, and not necessarily for describing or limiting its function in the present disclosure.

Where bias springs shown parallel to the strings, it is understood, where practical, that an alternative embodiment of the disclosure includes bias means at any angle, including normal to the string direction.

It is understood that any device configured to be combined with another device so that the combination yields a device equivalent to one or more elements of the present disclosure, also falls within the present disclosure.

### Additional Notes

Because the pitch of a string varies with the square root of the string stretch, and the scale of the invention is large, the invention is robust enough to allow significant deviation from optimal design without creating excessive transposing errors. Thus any configuration substantially equivalent to the preferred optimal configuration falls within the scope of the invention. The low angle of rotation allows strings to wrapped about geometrically wrong side of said guide or about a guide in a geometrically incorrect track without excessive harm to pitch accuracy. Guide means may be visually placed by measurement or by index marks included on the device, and a small error in placement will be undetected acoustically.

An embodiment of the invention taking advantage of said tolerance in a flat plate configuration may use fewer than the total complement of arcuate paths. It may also use additional (for example parallel to the high e path) non converging paths to allow flexibility in setting up said device for multiple tuning. Where multiple paths converge near the main pivot axis, one may continue while the others terminate short of the convergence point. Alternatively, a less preferred configuration may employ a perforated plate straight slots approximating the preferred configuration. (FIG. 15). Guides on straight or curved paths (on a flat plate tail piece, for example) may be configured to vary the angle from tangency among the strings to approximately compensate for neck flex.

A control arm axis normal to the string plane as disclosed herein is additionally beneficial when applied to acoustic guitars, where motion of the control handle will not conflict with vibratory rotation of the sounding board about the bridge.

Mechanical construction listed above is by way of example and conceptual schematic only. Any configuration functioning according to the described principles falls within the scope of this invention. In particular switching locations of cams and cam followers, rotating axes, and utilization of mechanical linkage in place of cams, or vice versa, falls under the scope of this invention.

Size, shape and location of components shown was selected for clarity of illustration, and not to illustrate a preferred size or shape or location. Variations, which may be obvious to those skilled in the art, fall within the scope of this invention.

Mounting locations and axes of control arm, cams, cam follower, transposing hub, or linkage may be interchanged, reversed, or inverted from that shown.

In FIGS. 21B-23D where balancing spring 40 or harmonic dive bias spring 122 extending from rotating member 8 within the instrument body is shown anchored to base extension 119b, it should generally be clear that said spring may alternatively be anchored to the base 68 or to the body 25 in lieu of or in addition to standard bias spring 123.

In an alternative embodiment to FIG. 16H of the parent, the fine tuner 10d shown may alternatively pivot about a guide 6, as in figures

Stops or other limiting devices may be relocated as desired.

String bearing means may serve also as bridge saddle means.

String guide means and string anchors may be combined into a single component or adjacent components, and ball cup anchor means may be pivotally suspended between guide means and bearing means.

The “substantially arcuate” adjusting path of string guides on a flat plate embodiment may include linear slots tangential to an arc as shown in FIG. 15, or discrete holes arranged in a suitable pattern.

Main rotating member pivot axis “substantially parallel” to the plane of the strings includes axes slightly oblique orientation to accommodate differences in crank length from lowE to highE.

Spring anchors shown in some drawings as rigid pins are schematic representations, and actual embodiments may be expected to include adjustable claw, or other spring adjustment means.

Bridge saddles preferably use grooved ball bearing saddles where the groove is preferably offset from the center of the bearing, as show in FIG. 32B thereby putting the balls in the ball race in a bind as shown in FIG. 32C. This binding action prevents rattle without increasing friction

The term “vibrato” used in this specification and claims is intended to include temporary increase or decrease in string pitch with or without oscillation.

Where an activation mechanism is disclosed by way of illustration as it is applicable to a given vibrato device configuration, it should be understood that the invention is not limited to a vibrato of that style or rotating about that same axis, but includes any vibrato device configuration to which it applies.

### Disclaimers

Where numbered elements in a figure are not described in the discussion of that figure, their basic descriptions may generally be taken to be substantially similar to elements of the same number described previously, where appropriate, and where the description is essential for understanding of the figure.

In most instances reference to a shaft element being oriented substantially normal to the string plane, for example, refers to the an angle at rest or neutral position, and encompasses any useable axis sufficiently askew to the standard vibrato fulcrum axis or the dive axis of the transport, for example, to allow rotation about one axis without interfering with rotation or stability about the other.

Pivot post brackets my be configured to include a fixed or adjustable (for example eccentric) post positioned to provide alignment of the moveable tailpiece in a direction parallel to a vector constructed between the pivot posts.

For figures related to electronic vibrato arm, it should be understood that at least one equivalent or alternative embodiment comprises a potentiometer as a rotation sensor.

Any single element or combination of elements disclosed herein whether from the same or different embodiments, falls within the scope of this disclosure. One or more elements of this disclosure may be combined with any known art or obvious improvement to create an embodiment falling within the scope of this disclosure.

It is to be understood that the illustrations, descriptions, and embodiments in this disclosure are by way of example only, and in no instance is any part of this disclosure intended to limit the scope of the disclosure or claims, regardless of the language used in the description.

Some of the embodiments described herein contain multiple novel features. Limitations which may be illustrated in the figures or described in the text of the specification, are not intended to limit the scope of the disclosure of any embodiment or of any claim or the use of a particular element to a given embodiment. A device incorporating some but not all of the teachings of a given embodiment falls within the scope of this disclosure. Each novel element described herein may be claimed individually. A device incorporating elements from two or more disclosed embodiments falls within the scope of this disclosure.

The location and orientation, of rotational axes, shafts, journals, cams and cam followers, transports, springs, and other disclosed mechanical components, and their association with other components of the devices disclosed are by way of example. It is understood that applying the teachings of this disclosure may involve change, interchange, reversal, or swapping of locations, orientations, and associations while maintaining the principles taught.

Any of the various methods available to scale the stretch of each string during actuation of a vibrato device, for example to maintain relative pitch, may be referred to as a proportioner.

A transport is preferably a mechanism allowing for displacement relative to a reference component of a first axis (associated with said transport) along or about a second axis, while resisting displacement of said first axis along or about other axes relative to said transport or relative to a reference component.

Pivot means disclosed or illustrated are for schematic illustration only, and it is understood that any pivot mechanism meeting the requirements of the device may be used, including knife edged fulcrum and journal and shaft. It is to be understood that illustration of any one pivot device does not amount to a disclosure of a preference for that device in any particular embodiment, unless expressly stated.

In every embodiment illustrated herein, it is understood that the type of springs and their attachment means and their location or orientation is by way of example only. Compressive springs, leaf springs, coil springs, torsion springs, or tensile springs may be used as may be appropriate. Where springs are illustrated without adjustment means, it is understood that any appropriate adjuster falls within the scope of the disclosure and claims.

The slope of a radial cam is generally expressed as dr/da where r is radius and a is angle of rotation. It should be understood that the sign of slope is generally a function of force direction, and not radius or height.

Device may be constructed of any solid material having adequate strength and rigidity. Polished plated steel is a preferred material for economical fabrication. Polished stainless steel is preferred material to eliminate a plating step in smaller lots.

Instruments fitted with the disclosed devices and methods of retrofitting existing instruments with the disclosed elements also fall within the scope of the invention.

I claim:

1. Control apparatus for a pitch changing device for a musical instrument,
said instrument having at least two strings suspended in tension relative to a body, a major span of said stings substantially defining a string plane,
said pitch changing device comprising a first member adapted to directly or indirectly engage at least two said strings, such that displacement of said first member relative to a base from a neutral position causes a change in tension of said at least two strings,
said apparatus comprising:
at least one fulcrum defining at least one control axis,
a control lever pivotable about at least one said axis,
at least one spring,
a handle attached to or defined by an end of said control lever distal from said axis or axes and moveable in first and second operative directions,
said lever adapted to directly or indirectly operatively engage said first member, such that rotation of said handle in one of said two operative directions about an axis causes an increase in tension of at least one string, and motion of said handle in the other operative direction causes a decrease in tension of at least one string,
said body defining opposed face and back planes, said face plane substantially between said string plane and said back plane,
said back plane defining a reference plane, said reference plane substantially parallel to said string plane,
said handle, when at rest, substantially defining the location of a normal plane, said normal plane normal to said reference plane and parallel to at least one string,
Rotation of said lever in said first direction causing said handle to move predominantly away from said normal plane, rotation of said lever in said second direction causing said handle to move predominately toward said reference plane.

2. Control apparatus according to claim 1 said apparatus comprising:
at least one fulcrum defining first and second discrete control axes,
the direction of said first control axis configured to be substantially normal to the direction of said second axis when said lever is at said neutral position,
said control lever pivotable in said first control direction about said first control axis and in said second control direction about said second control axis.

3. Control apparatus according to claim 2 and further comprising
first and second fulcrums defining said first and second discrete control axes,
a fulcrum connector adapted to connect said first and second fulcrums, said connector adapted to substantially fix said first and second control axes relative to each other,
said fulcrum connector defining a transport,
said control lever pivotable relative to said transport in said first control direction about said first axis from a neutral position,
said transport pivotable in said second control direction about said second axis from a neutral position relative to said base or to said first member,
such that rotation of said lever in said second control direction about said second axis causes rotation of said transport in said second control direction about said second axis,
said lever adapted to operatively engage said first member and said base such that motion of said handle in a first control direction substantially tangential to said first axis displaces said first member in a direction of increasing string tension,
said lever adapted to be urged toward said neutral position from said rotation by engagement of said first member with said strings,
said device adapted to operatively engage said first member and said base such that rotation of said transport from said neutral position displaces, or enables string tension to displace, said first member in a direction of reduced string tension,
at least one said spring adapted to urge said transport toward said neutral position from said rotation when said arm is released,
said apparatus configured such that at said neutral position one said control axis extends in a direction substantially normal to a plane substantially defined by said strings, while the other extends in a direction substantially normal to said strings and parallel to a plane defined by said strings.

4. Pitch control apparatus according to claim 3,
said base or said first member defining a transport base,
said second fulcrum adapted to connect said transport to said transport base,
said apparatus comprising surfaces of engagement between said transport and transport base, said surfaces defining a dive bias stop,
at least one said spring adapted to urge rotation of said transport in a direction of engagement of said said dive bias stop,
engagement of said dive bias stop defining a neutral position,
said apparatus configured such that rotation of said transport from engagement of said dive bias stop displaces the engagement of said lever with said first member or base such that said first member is displaced in a direction of reduced string tension.

5. Control apparatus according to claim 3, said base defining a first base displaceable relative to a second base, said apparatus comprising said first base.

6. A transposing device for a pitch change apparatus for a stringed musical instrument,
said apparatus comprising
a control lever,
a first member displaceable relative to a base,
at least one bias limiter,
said first member adapted to directly or indirectly engage a complement of at least two strings, such that displacement of said first member from a home position relative to said base causes a change in tension of said strings,
said apparatus configured or adjustable to maintain relative pitch among said at least two strings during said displacement of said first member from said home position,
said bias limiter comprising first and second components, said components adapted to be directly or indirectly associated with said first member and said base, respectively,
said bias limiter adapted to statically resist displacement in a bias direction of said first member from said home position,
said first member urged in said bias direction by string tension or a bias spring opposing said string tension,
said lever adapted to directly or indirectly engage said first member and said base, such that rotation of said lever about a control axis displaces said first member from said home position,
said transposing device comprising an adjuster,
said adjuster comprising a transposing hub pivotable about a transposing axis,
said hub discrete from said control lever,
said adjuster defining a transposer,
said transposer adapted to directly or indirectly engage said bias limiter,
such that rotation of said hub displaces one of said first and second components of said bias limiter relative to said first member, said base, or said lever,
said displacement of said component by said transposer displacing said home position of said first member relative to said base,
said transposer comprising a lock engageable and disengageable by a user,
said lock adapted to enable temporarily fixing said hub at an angle of rotation defining a transposed home position,
such that subsequent rotation of said control lever in at least one direction causes a displacement of said first member from said transposed home position, and upon release of said lever, said first member is biased toward said transposed home position.

7. A device according to claim 6 where said transposer comprises an idler,
said idler adapted to operatively link said transposing hub with a component of said bias limiter,
said idler adapted to displace said component relative to said first member or said base or said lever when said transposing hub is rotated in at least one direction about said transposing axis,
where the angular displacement of said idler is smaller than that of said transposing hub within the operative range of said hub.

8. Control apparatus according to claim 2,
said first member pivotable about said second axis relative to said base,
said lever pivotable about said first axis,
said first axis oblique to said first member and fixed relative thereto, with said lever adapted to operatively engage said base,
such that rotation of said lever in a first direction about said first axis displaces said first member angularly about said second axis from a biased position,
said oblique angle of said first axis chosen such that the combined said rotation of said lever and said first member about their respective axes results in motion of said lever substantially in a plane substantially parallel to the plane of said strings.

9. Control apparatus according to claim 2,
said apparatus comprising at least one sensor
at least one said sensor adapted to vary at least one detectable electronic property with rotation of said control lever about at least said first axis,
said varying of said property defining a signal,
said first axis at rest adapted to extend in a direction substantially normal to a plane defined by said strings,
said sensor adapted to be connected to a signal processor,
said connection enabling said signal to be communicated to said processor,
said signal enabling a processor to determine a value corresponding to an angle of rotation of said lever about said first axis within an operable range.

10. Control apparatus according to claim 9,
said apparatus comprising a connector adapted to connect said lever to first member,
said first member pivotable about said second axis,
said second axis having a direction substantially normal to said strings and substantially parallel to said string plane,
such that rotation of said lever about said second axis rotates said first member about said second axis.

11. A device according to claim 7, where engagement of said idler with said hub or with said bias limiter comprises a mechanical component selected from a list comprising cam, roller, rocker, crank, and screw.

12. A biasing apparatus for a pitch changing device for a musical instrument, said instrument having multiple strings suspended in tension, where said pitch changing device is adapted to alter the tension of one or more strings in response to motion from a neutral position of either of at least two string-engaging members relative to a base, said apparatus comprising
first and second members, each displaceable relative to a base, each adapted to engage a discrete complement of at least one string,
at least one bias spring engaging said first member in opposition the tension of said at least one string,
a first stop comprising surfaces of engagement between said first and second members,
said spring adapted to urge said first member in a direction of engagement with said second member at said first stop,
said second member adapted to urge said first member in a direction of reduced string tension by engagement at said first stop,
a control lever adapted to enable manual displacement of said second member at least in a direction of increasing string tension from a neutral position,
such that said displacement enables said at least one bias spring to displace said first member in a direction of increasing string tension.

13. An apparatus according to claim 12 and further comprising a second stop,
said second stop comprising surfaces of engagement between said first member and said base,
such that, once engaged, said stop resists motion of said first member in a direction of increasing string tension.

14. A control apparatus for a pitch change device for a stringed musical instrument, said instrument comprising multiple strings suspended in tension, said apparatus comprising:
a compensator,
first and second members, each adapted to directly or indirectly engage a substantially common set of at least two strings,
a main fulcrum comprising a main axis,
said first member pivotable about said main axis such that angular displacement of said first member about said main axis results in an increase or decrease of string tension within said set,
said engagement of said first member with said at least one string adapted to or adjustable to substantially maintain relative pitch among at least two said strings during initial rotation of said first member about said main axis from a neutral position,
said second member adapted to displaceably engage said strings such that displacement of said second member causes a more uniform increase or decrease in string tension than that of said first member,
said apparatus comprising at least one user-displaceable control member, displacement of said control member adapted to change the angle of rotation of said first member about said main axis,
said compensator adapted to mechanically translate displacement of said control member or of said first member into displacement of said second member relative to said base,
said compensator comprising at least one adjuster,
said at least one adjuster adapted to enable said translation to be characterized by a user,
such that displacement of said second member by said compensator substantially offsets deflection of said instrument due to rotation of said first member about said main axis.

15. Pitch control apparatus according to claim 14, said apparatus comprising:
bridge saddles substantially defining a bridge,
said bridge saddles associated with said second member,
said main fulcrum adapted to connect said first and second members,
said main axis substantially parallel to said bridge,
said first member pivotable about said main axis relative to said second member,
such that displacement of said second member relative to said base causes like displacement of said first member relative to said base,
said bridge second member configured such that displacement of said second member in a direction of reduced string tension elevates said bridge saddles from said instrument body.

16. Pitch control apparatus according to claim 15, said apparatus comprising:
at least one bias spring,
a base fulcrum defining a base axis substantially parallel to said bridge,
said second member adapted to be angularly displaceable about said base axis relative to said base,
said at least one bias spring adapted to urge said second member in a direction of increasing string tension,
said compensator comprising a bias limiter,
said bias limiter comprising surfaces associated with said second member and said base,
engagement of said bias limiter surfaces resisting rotation of said second member in a direction of increasing string tension,
said at least one bias spring urging engagement of said bias limiter surfaces,
said compensator adapted to displace one of said bias limiter surfaces relative to said base or said second member,
such that said displacement of said bias limiter surface displaces said second member relative to said base in a direction of reduced string tension.

17. Pitch control apparatus according to claim 16,
said bias limiter comprising a cam and cam follower,
said cam comprising a displacing surface, engagement of said cam and cam follower urging said second member in a direction of reduced string tension,
said compensator adapted to associate said cam or follower with said first member or said control member such that rotation of said first member about said main axis or displacement of said control member alters the position of said cam relative to said follower,
said at least one adjuster adapted to adjust the position said cam relative to said follower or to adjust the slope of a cam surface.

18. Apparatus according to claim 2 where said engagement of said control apparatus with said pitch changing device comprises
first and second rollers adapted to have substantially skew axes,
said first roller directly or indirectly associated with said control lever,
said second roller directly or indirectly associated with a base or said first member,
said control lever pivotingly associated with said base or said first member,
said first roller adapted to be compressively engaged with said second roller in direct or indirect opposition to string tension or bias spring force
such that rotation of said control lever in at least one direction about said at least one axis causes displacement of said first member relative to said base.

19. A device according to claim 18, at least one of said rollers configured with an axial contour, such that during rotation of said lever in at least one direction about at least one said axis the purchase of said lever urging or enabling displacement of said first member varies according to the angular displacement angle of said lever.

20. A control apparatus according to claim 1,
said apparatus comprising a first fulcrum defining a first control axis substantially parallel to the major span of a string,
said first and second control directions tangential about said first axis,
said first control direction defining angular displacement in an opposite direction about said first control axis from said second control axis.

21. Control apparatus according to claim 2, said apparatus comprising
first and second brake surfaces,
said first brake surface associated with said control lever,
said second brake surface associated with one of said first member and said base,
said first brake surface substantially cylindrical about said first control axis,
said brake surfaces adapted to be urged into braking engagement by the urging of said first member in a direction of reduced string tension by said strings,
such that engagement of said brake surfaces resists rotation of said lever about said first axis when said device is at rest,
and such that said brake surfaces disengage when said lever is rotated from an at-rest position in a direction of increasing string tension.

22. Control apparatus according to claim 9, said apparatus comprising
a base fulcrum defining a base axis,
said first base pivotable about said base axis relative to said second base,
said base axis substantially parallel or coaxial to said second axis,
said first base engaging at least one base bias spring,
said base bias spring urging said base in a direction of increasing string tension to a biased position relative to said second base.

23. Control apparatus according to claim 22, said apparatus comprising
third and fourth surfaces associated with said transport and said transport base respectively,
said third and fourth surfaces defining a dive stop, engagement of said surfaces limiting rotation of said transport from said neutral position,
an adjuster adapted to enable a user to position at least one surface of said dive stop at a position defining a user selected angular limit to said rotation of said transport from said transport base,
such that rotation of said lever in said second direction beyond said angular limit rotates said first base about said base axis from said biased position.

24. A control device for a pitch changing mechanism on a stringed instrument, said mechanism comprising a first member adapted to alter the tension of at least two strings when said first member is moved in an operative direction relative to a base, said device comprising
at least one bias limiter,
at least one bias spring adapted to urge said first member in a direction of increasing string tension,
a cam mechanism,
said cam mechanism comprising first and second components, one of said first and second components comprising a cam having a displacing surface, and the other of said components comprising a cam follower,
said first and second components directly or indirectly associated with first bias spring and said base, respectively,
said at least one bias spring adapted to urge engagement of said first component with said second component, engagement of said first and second components resisting displacement of said first member in a direction of increasing string tension,
said engagement of first and second components defining a biased position of said first member,
such that altering the engagement of said displacing surface with said cam follower enables a user to alter the biased position of said first member.
